(19) United States
(12) Patent Application Publication
(10) Pub. No.: US 2019/0214923 A1
(43) Pub. Date: Jul. 11, 2019

(54) ACOUSTIC ENERGY MANAGEMENT SYSTEMS AND METHODS OF MAKING AND USING SAME

(71) Applicant: NEWTONOID TECHNOLOGIES, L.L.C., LIBERTY, MO (US)

(72) Inventors: FIELDING B. STATON, LIBERTY, MO (US); DAVID STRUMPF, COLUMBIA, MO (US)

(21) Appl. No.: 16/246,220

(22) Filed: Jan. 11, 2019

Related U.S. Application Data
(60) Provisional application No. 62/616,321, filed on Jan. 11, 2018.

(51) Int. Cl. H02N 2/18; G06F 3/0484

(52) U.S. Cl. CPC H02N 2/181; H02N 2/186; G06F 3/04847

(57) ABSTRACT

An acoustic energy management system comprises an energy receiving device configured to receive an acoustic signal within an input range and an energy dispensing device configured to output a modified signal in response to the acoustic signal. The system includes a computing device coupling the energy receiving device to the energy dispensing device. The system has a user interface comprising an analog actuator. The input range is user selectable.

### CROSS-REFERENCE TO RELATED APPLICATIONS

This application claims priority to U.S. Provisional Patent Application, Ser. No. 62/616,321, filed Jan. 11, 2018, the disclosure of which is incorporated herein by reference in its entirety.

### FIELD OF THE DISCLOSURE

The disclosure relates generally to the field of energy management systems. More specifically, the disclosure relates to systems for managing acoustic energy and to methods of making and using such systems.

### SUMMARY

Systems and methods for managing acoustic energy are disclosed herein. In an embodiment, an acoustic energy management system comprises an energy receiving device configured to receive an acoustic signal within an input range and an energy dispensing device configured to output a modified signal in response to the acoustic signal. The system includes a computing device coupling the energy receiving device to the energy dispensing device. The computing device is configured to dynamically adjust the input range. A portable housing is included for housing each of the energy receiving device and the energy dispensing device.

In another embodiment, a method of managing an acoustic signal includes using an energy receiving device to receive an acoustic signal within an input range. The method comprises processing the acoustic signal and using an energy dispensing device to output the processed acoustic signal. The method includes configuring a computing device to dynamically adjust the input range.

In yet another embodiment, an acoustic energy management system comprises an energy receiving device configured to receive an acoustic signal within an input range and an energy dispensing device configured to output a modified signal in response to the acoustic signal. The system includes a computing device coupling the energy receiving device to the energy dispensing device. The system has a user interface comprising an analog actuator. The input range is user selectable.

### BRIEF DESCRIPTION OF THE SEVERAL VIEWS OF THE DRAWINGS

Illustrative embodiments of the present disclosure are described in detail below with reference to the attached drawing figures.

FIG. 1 is a schematic diagram of an acoustic energy management system, according to an embodiment of the present disclosure.

FIG. 2 is a front view of an example housing of the acoustic energy management system of FIG. 1.

FIG. 3 is a functional block diagram depicting a computing system of the acoustic energy management system of FIG. 1.

FIG. 4 is a flowchart illustrating an example method of using the acoustic energy management system of FIG. 1.

### DETAILED DESCRIPTION

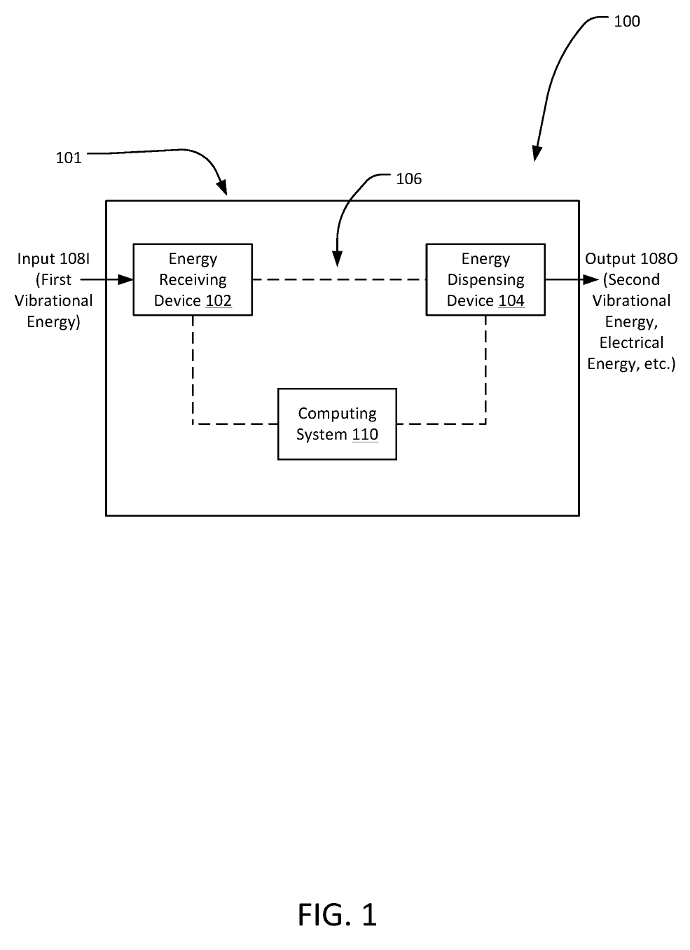

The disclosure relates to systems and methods for managing vibrational energy, e.g., for acoustic applications. FIGS. 1 through 3 show an acoustic energy management system 100, according to an example embodiment. The acoustic energy management system 100 comprises a housing 101, an energy receiving device 102, an energy dispensing device 104, and optionally, a computing system 110.

The housing 101 may encapsulate one or more of these components, and any other components of the system 100, in whole or in part. In embodiments, the housing 101 may be portable and/or handheld.

The energy receiving device 102 may be coupled to the energy dispensing device 104 via a connection 106. The connection 106 may be a direct connection (e.g., a wired connection, a physical connection, etc.), an indirect connection (e.g., the energy receiving device 102 may be in communication with a processor that is also in communication with the energy dispensing device 104, the energy receiving device 102 may communicate with the energy dispensing device 104 over a network, etc.), or include aspects of both.

In embodiments, the acoustic energy management system 100 may be configured to receive an input 1081 and provide an output 1080 in response thereto. The input 1081 may be a first vibrational energy. The output 1080 may be a second vibrational energy obtained by selectively manipulating the first vibrational energy, and/or a different type of energy (e.g., a Bluetooth low energy (BLE) beacon signal). In some embodiments, the energy receiving device 102 and the energy dispensing device 104 may be the same device (i.e., in embodiments, the energy receiving device 102 and the energy dispensing device 104 may be a solitary device that receives the first vibrational energy 1081 and provides output 1080 based on the first vibrational energy 1081).

The energy receiving device 102 may be any device or combination of devices that allows for the vibrational energy generated in response to an acoustic signal to be captured and/or selectively captured. The energy receiving device 102 may, in embodiments, be a tuned cup or port having a vibrating member placed therein. In embodiments, the energy receiving device 102 may employ components traditionally employed in loudspeakers and/or microphones to receive acoustic energy information, such as a movable diaphragm, a movable ribbon, a coil and permanent magnet, et cetera.

The energy receiving device 102 may, in embodiments, be configured to receive or selectively receive vibrational energy generated in response to the operation of an acoustic device. For example, the energy receiving device 102 may be configured to receive or selectively receive vibrational energy generated by a surface (such as a table) on which an acoustic device is placed. In embodiments, the system housing 101 may be situated proximate or on (e.g., on the foot of or elsewhere) a conference room phone, a speaker, or other acoustic device. When the acoustic device (e.g., a speakerphone) emits sound waves, these sound waves may cause a surface (e.g., of a table on which the speakerphone is placed) to vibrate at a frequency, such as a fundamental or harmonic resonant frequency. The vibrations of the surface may cause the tuned cup or other energy receiving device 102 to also selectively vibrate. In some embodiments, the tuned cup or port may also receive vibrational energy directly from the acoustic device.

In some embodiments, the energy receiving device 102 may comprise a contact 103 to facilitate reception of acoustic energy information (e.g., vibrational energy). The contact 103 may be a sensor, such as an accelerometer (e.g., piezoelectric, optical, resonance, surface acoustic wave, etc.), a geophone, a microelectromechanical system (MEMS), a proximity sensor (e.g., capacitive, photoelectric, magnetic, etc.), an interferometer, et cetera. In embodiments, a combination of different types of sensors may be used as the contact 103 to receive vibrational energy (e.g. piezo surface films, haptic contactless culmination in the air, thermoelectric oscillating ceramics, etc.). In some embodiments, the housing 101 makes up some or all of the contact 103 (i.e., the energy receiving device 102 may use the housing 101 to receive the vibrational energy from the acoustic device, such as through direct contact of the housing 101 with the vibrating acoustic device or surface). In operation, the contact 103 may be configured to receive vibrational energy signals directly (e.g., the contact 103 may physically touch the acoustically vibrating object) or indirectly (e.g., the contact 103 may gather energy information using a medium, the contact 103 may gather energy information remotely via a sensor, optics, haptics, et cetera). The medium utilized by an indirect contact 103 may be any suitable material for transferring vibrations, such as air, a liquid, a solid, a resilient material, an elastically deforming material, a combination of mediums, et cetera. The energy received and/or selectively received by the energy receiving device 102 may in-turn be manipulated and dispensed by the energy dispensing device 104 as the output 1080, as discussed herein.

In embodiments, the energy receiving device 102 may selectively receive the vibrational energy by accepting only specific ranges of frequencies (herein, an “input range”), such as vibrational energy whose frequency is within the audible range (e.g., is between 20 Hz to 20,000 Hz). Such may be accomplished using filters, such as active compressors, expanders, attenuators, amplifiers, parametric filters, passive filters, digital filters, etc., or via other means. In some embodiments, the energy receiving device 102 may selectively receive vibrational energy by rejecting vibrational energy within certain ranges, such as by rejecting frequencies associated with infrasound (e.g., between 0.1 Hz and 60 Hz). In operation, the energy receiving device 102 may be configured to selectively reject one or more ranges of frequencies, allow one or more ranges of frequencies, and/or some combination thereof.

The various ranges of frequencies that are selectively received by the energy receiving device 102 may be configurable by a user. For example, the housing 101 may have associated with it a user interface 109 (e.g., buttons, knobs, toggles, switches, touchscreens, graphical user interfaces, etc.) configured to allow a user to modify the operation of the acoustic energy management system 100. In operation, the user interface 109 may allow a user to modify the operation of one or more components of the acoustic energy management system 100 (e.g., the energy receiving device 102, the energy dispensing device 104, the computing system 110), such as by adjusting the ranges of accepted frequencies of vibrational energy, modifying the transduction of the vibrational energy, and/or modifying other operations of the device 100 as discussed herein. Alternately or in addition to being associated with the housing 101, the user interface 109 may be associated with the computing system 110.

The energy dispensing device 104 (also referred to herein as an “energy transducing device”) may manage the energy received by the energy receiving device 102 and provide the output 1080 in response thereto. For example, in embodiments, the energy dispensing device 104 may include a resonator (e.g., an acoustic resonator, a cavity resonator, a tuned circuit, tuned ported cavities, etc.) and/or a transducer. In these embodiments, the resonator may be configured to modify (e.g., amplify, equalize, phase modulate, echo cancel, time shift, change, etc.) the vibrational energy received or selectively received by the energy receiving device 102 and the transducer may be configured to convert the vibrational energy into other energy, such as electrical energy or a second vibrational energy. Alternately or additionally, the energy dispensing device 104 may comprise a resonator (e.g., an acoustic resonator, a cavity resonator, a tuned circuit, etc.) and a movable diaphragm. In these embodiments, the resonator may amplify the vibrational energy and the motion of the movable diaphragm caused thereby may generate acoustic energy that amplifies the sound of the acoustic device.

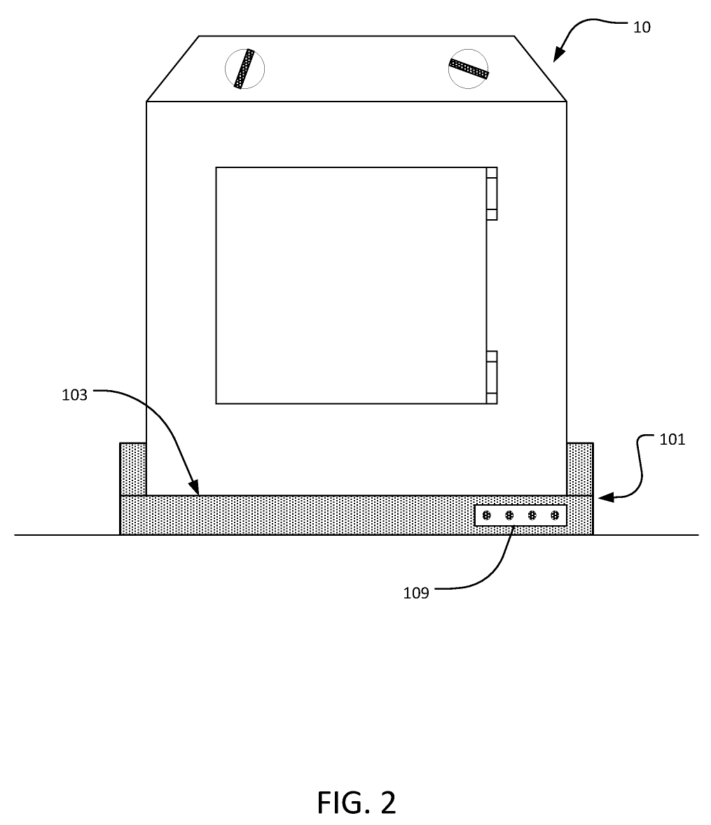

The acoustic energy management system 100 may, alternately or in addition to amplifying (e.g., increasing decibel level, modifying the frequency distribution, modify the time distribution, normalize, etc.) the sound of an acoustic device, be usable to cancel the sound or noise generated by the acoustic device or another device. For example, in embodiments and as illustrated in FIG. 2, the acoustic energy management system 100 may be situated on a surface (such as the ground or a table top) that is vibrating in response to the noise generated by an operating dishwasher, washing machine, dryer, and the like (herein, “noisy device 10”). In these embodiments, the acoustic energy management system 100 may be configured to actively and/or passively cancel the noise generated by the noisy device 10. For example, where the acoustic energy management system 100 is an active system, it may generate its own sound that, akin to noise canceling headphones, drowns out the noise of the noisy device 10 by superimposing an out-of-phase acoustic signal over the noisy signal. Where the acoustic energy management system 100 is a passive device, it may, for example, dampen (e.g., via materials with a high damping coefficient, with sound absorbing materials, etc.) the received acoustic signal and/or store the vibrational energy generated in response to the operation of the noisy device 10 for use in other applications. For example, in embodiments, the harvested vibrational energy may be converted (e.g., via an alternator, a dynamo, a piezo element, etc.) to electrical energy that is stored in a battery of the acoustic energy management system 100 or elsewhere. In some embodiments, the harvested vibrational energy may be converted by the system 100 to acoustic energy or a different type of energy (e.g., Bluetooth).

In embodiments, the operation of the acoustic energy management system 100 may be direction-dependent. For example, the acoustic energy management system 100 may, in embodiments, be configured to cancel (or otherwise modify, phase differentiate, etc.) vibrational energy in front of (or behind, to the side of, etc.) the housing 101. In embodiments, the system 100 may be configured to cancel (or otherwise modify) vibrational energy at a particular frequency (e.g., a frequency unlikely to be associated with an acoustic device, subsonic, ultrasonic, etc.). In embodiments, the noise canceling of the system 100 may be directional, frequency, and dynamically perspective based.

In embodiments, and particularly where the system 100 is usable for noise canceling, the acoustic energy management system 100 may be placed in a car, e.g., at the underside thereof. The system 100 may cancel all or part of the noise generated because of the movement of the car (e.g., cancel out the sounds of the car's panels that are moving in response to the ambient vibrations), and may further harvest this vibrational energy (i.e., noise as well as intentional sound) for use in other applications, such as charging a car battery.

In embodiments, the resonant frequency of the acoustic energy management system 100 may be changeable. For example, in embodiments, the system 100 may have a knob(s), toggle(s), and/or switch(es) associated with user interface 109 that may be manipulated to adjust the resonant properties of the system 100, such as by adjusting the frequency range passband, bandwidth, and phase of a bandpass filter used in the energy receiving device 102.

In some embodiments, the operation of the energy transducing device 104 may be user configurable. For example, a user may modify the operation of the energy transducing device 104 via the user interface 109 (e.g., the user interface associated with the housing 101 and/or the computing system 110). In operation, a user may selectively configure the energy transducing device 104 to amplify certain frequency ranges of vibrational energy, cancel certain frequency ranges of vibrational energy, modify a magnitude with which the frequency ranges are amplified and/or canceled, modify the resonant properties of the acoustic energy management system 100, modify the direction-oriented canceling of the acoustic energy management system 100, and/or otherwise transduce certain frequency ranges of vibrational energy.

In some embodiments, the system 100 may be devoid of electrical components (i.e., the energy receiving device 102 and the energy dispensing device 104 may each function in the non-electrical domain without the use of a processor, memory, and other electronics). In other embodiments, the system 100 may include a processor, an input/output device, a memory comprising programming instructions configured to facilitate the conversion of the input energy 1081 into the output energy 1080, et cetera.

The acoustic energy management system 100 may, in embodiments, receive acoustic energy only within a user-defined or other frequency band. In embodiments, the energy management system 100 may alternately or additionally use other properties of the vibrational energy to filter same, such as decibel level, pitch, tone, duration, loudness, timbre, sonic texture, spatial location, et cetera. The system 100 may likewise allow for one or more of these other properties to be modified (e.g., the energy receiving device 102 may include a microphone and the energy dispensing device 104 may include a speaker which may collectively be used to modify a decibel level of the acoustic signal).

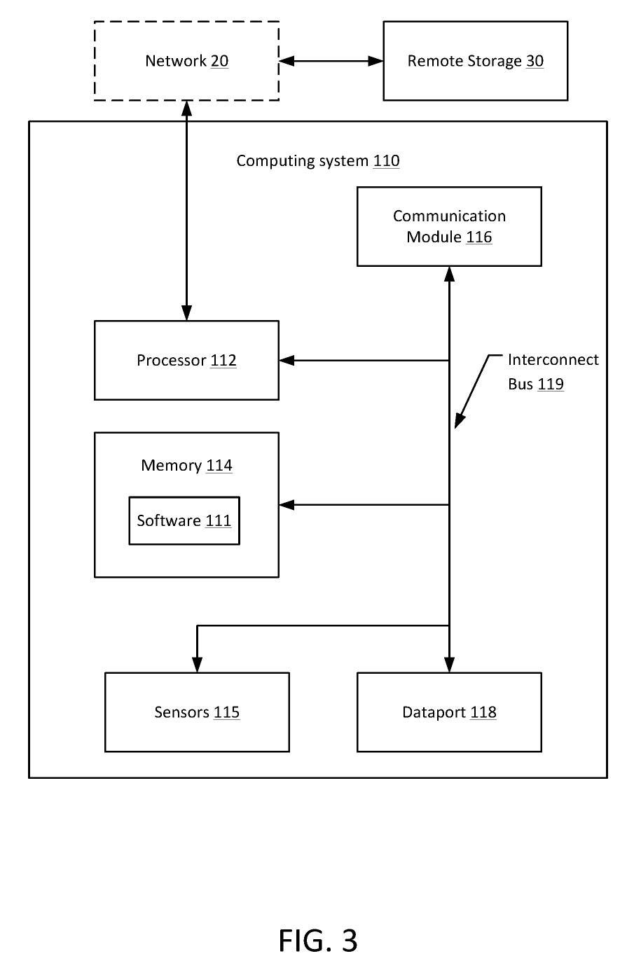

FIG. 3 is a functional block diagram of a computing system 110 which may be used to implement the various embodiments of the acoustic energy management system. The computing system 110 may be, for example, a smartphone, a laptop computer, a desktop computer, a circuit board, or other computing device whether now known or subsequently developed. In some embodiments, at least some of the components of the computing system 110 are disposed within the housing 101.

The computing system 110 may include a processor 112, a memory 114, a sensor 115, a communication module 116, and a dataport 118. These components may be communicatively coupled (e.g., wired and/or wirelessly) together by an interconnect bus 119. A user may interact with the computing system 110 via a user interface, such as a graphical user interface, a display, a computer monitor, a touch screen, et cetera. The processor 112 may include any processor used in smartphones and/or other computing devices, including an analog processor (e.g., a Nano carbon-based processor, organic, biological, neurological processor) or microcontroller. In certain embodiments, the processor 112 may include one or more other processors, such as one or more microprocessors, and/or one or more supplementary co-processors, such as math co-processors.

The memory 114 may include both operating memory, such as random access memory (RAM), as well as data storage, such as read-only memory (ROM), hard drives, optical, flash memory, or any other suitable memory/storage element. The memory 114 may include removable memory elements, such as a CompactFlash card, a MultiMediaCard (MMC), and/or a Secure Digital (SD) card. In certain embodiments, the memory 114 may include a combination of magnetic, optical, and/or semiconductor memory, and may include, for example, RAM, ROM, flash drive, and/or a hard disk or drive. The processor 112 and the memory 114 each may be located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 112 may be connected to the memory 114 via the dataport 118.

The sensor 115 may be communicatively linked to the computing system 110 (e.g., via the communications module 116, the dataport 118, the interconnect bus 119, etc.) and may be used to detect or sense the motion (e.g., vibrations) of an object (e.g., an acoustic device, a surface, et cetera). The type of sensor used may be, for example, an accelerometer (e.g., piezoelectric, optical, resonance, surface acoustic wave, etc.), a geophone, a microelectromechanical system (MEMS), a proximity sensor (e.g., capacitive, photoelectric, magnetic, etc.), or an interferometer. In some embodiments, a combination of different types of sensors 115 may be used to detect the motion of an object. In operation, the sensors 115 may be configured to sense the motion of an object for the purposes of relaying the motion information to other parts of the acoustic energy management system 100 (e.g., the computing system 110, the energy dispensing device 104). The computing system 110 may respond to the motion information (e.g., by having software 111 calculate an anticipatory motion pattern of the object, modifying the operation of the energy dispensing device 104, et cetera). In some embodiments, a plurality of sensors 115 may be used.

The communication module 116 may be configured to handle communication links between the computing system 110 and other internal/external devices or receivers, and to route incoming/outgoing data appropriately. For example, inbound data from the dataport 118 may be routed through the communication module 116 before being directed to the processor 112, outbound data from the processor 112 may be routed through the communication module 116 before being directed to the dataport 118, and communication between the energy receiving device 102 and the energy dispensing device 104 may be routed through the communication module 116. The communication module 116 may include one or more transceiver modules configured for transmitting and receiving data, and using, for example, one or more protocols and/or technologies, such as Bluetooth, GSM, UMTS (3GSM), IS-95 (CDMA one), IS-2000 (CDMA 2000), LTE, FDMA, TDMA, W-CDMA, CDMA, OFDMA, Wi-Fi, WiMAX, 5G, or any other protocol and/or technology. In some embodiments, operation of the computing system 110 may be modified via the communications module 116. For example, an external device, such as another computing system, may communicate with the computing system 110 via the communications module 116, and may send commands for directing the operation of the computing system 110. In still other embodiments, the communications module 116 may communicatively link with the energy receiving device 102 and the energy dispensing device 104 for the direction of the devices 102, 104 by the computing system 110.

In some embodiments, the communications module 116 may interact with a sensor (e.g., the sensor(s) 115) remote from the housing 101 and/or one or more other components of the system 100. For example, the communications module 116 may receive and communicate to the processor of the computing system 110 a signal from a remote sensor configured to sense the motion of an object. In embodiments, the communication module 116 may allow for interaction between an energy receiving device 102 and an energy dispensing device 104 remote therefrom.

The dataport 118 may be any type of connector used for physically interfacing with a smartphone, computer, and/or other devices, such as a USB or mini-USB port. In other embodiments, the dataport 118 may include multiple communication channels for simultaneous communication with, for example, other processors, servers, and/or client terminals. Alternately or additionally, the dataport 118 may be configured to communicatively link (e.g., wirelessly through the network 20) to components, such as the sensing device 115.

The memory 114 may store instructions for communicating with other systems, such as a computer. The memory 114 may store, for example, a program (e.g., computer program code) adapted to direct the processor 112 in accordance with the present embodiments. The instructions also may include program elements, such as an operating system. While execution of sequences of instructions in the program causes the processor 112 to perform the process steps described herein, hard-wired circuitry may be used in place of, or in combination with, software/firmware instructions for implementation of the processes of the present disclosure. Thus, unless expressly noted, the disclosure is not limited to any specific combination of hardware and software.

In some embodiments, the memory 114 may include software 111 (i.e., machine readable instructions) configured to be executed by the processor 112. The software 111 may, for example, process data obtained from the sensing device 115. In some embodiments, the software 111 may cause the computing system 110 to dynamically respond to a reading obtained by the sensing device 115 and/or the energy receiving device 102. For example, the computing system 110 together with the software 111 may modify the range of frequencies being input to the acoustic energy management system 100 based upon a determination that there is an undesirable amount of noise in the signal entering the system 100.

In some embodiments, the software 111 may use an algorithm to allow for conversion of the acoustic energy received by the energy receiving device 102. For example, the software 111 may use an algorithm to predict the vibration of the object to better receive energy therefrom, may use an algorithm to determine a desirable operation of the energy dispensing device 104, et cetera. In some embodiments, the software 111 may have machine readable instructions configured to enact some or all of the operations of the user interface 109. For example, the software 111 may include instructions for a graphical user interface and/or an analog interface that allows a user to modify the operation of components of the acoustic energy management system 100 (e.g., the energy receiving device 102, the energy dispensing device 104, etc.), as described above.

The computing system 110 may be in data communication with remote storage 30 over the network 20. The network 20 may be a wired network, a wireless network, or comprise elements of both. The remote storage 30 may be, for example, the “cloud” or other remote storage in communication with other computer systems. In some embodiments, data (e.g., readings obtained by the sensing device 115 and the dynamic responses of the computing system 110 thereto) may be stored in the remote storage 30 for analytics and/or for otherwise sending the data to other acoustic energy management systems 100 for use thereof. In some embodiments, at least some of the components of the acoustic energy management system 100 may communicate with each other via the network 20 (e.g., the computing system 110 may communicate with the energy receiving device 102 and/or the energy dispensing device 104 via the network 20).

As noted, the energy receiving device 102 may selectively receive the vibrational energy by accepting only specific ranges of frequencies within the input range. The input range may be settable by a user, e.g., via the user interface 109. Alternately or in addition, the input range may be set by the computing system 110, e.g., via the processor 112 and software 111 thereof. In embodiments, the software 111 may include instructions for dynamically adjusting the input range of the energy receiving device 102. For example, in embodiments, the energy receiving device 102 may have a digital filter associated therewith and the computing system 110 may employ the digital filter to dynamically adjust the input range. Such may, e.g., allow for noise to be canceled or reshaped while other sounds are amplified or optimized.

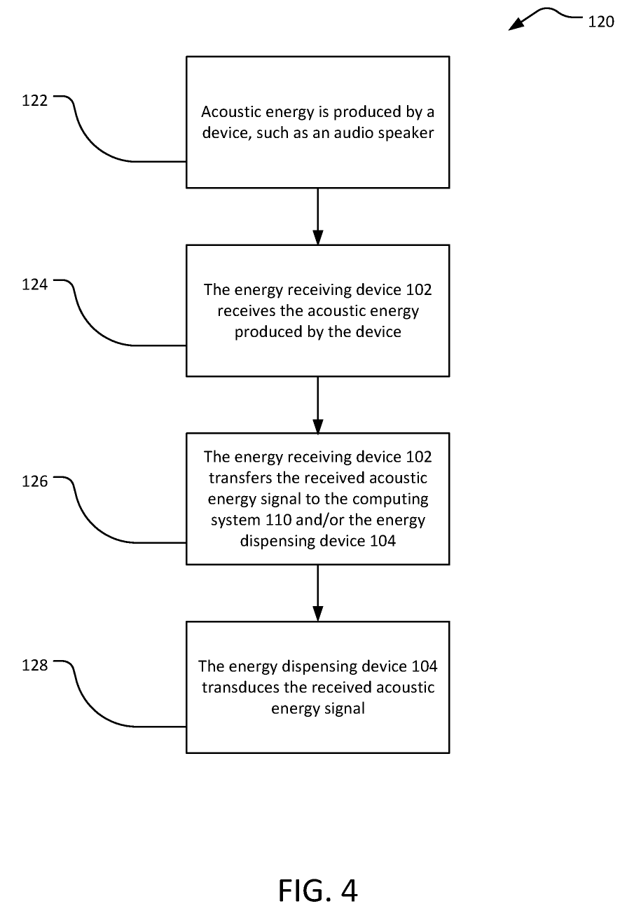

FIG. 4 illustrates a method 120 for operating the acoustic energy management system 100. First, at step 122, an acoustic device may produce acoustic energy, which may cause an object associated with (e.g., in contact with) the energy receiving device 102 to vibrate. For example, an audio speaker disposed on a table surface may produce acoustic energy that causes the table surface and/or the housing 101 of the acoustic energy management system 100 to vibrate. Next, at step 124, the energy receiving device 102 may receive within an input range the vibrational energy generated in response to operation of the acoustic device. For example, the energy receiving device 102 may use the contact 103, the sensor 115, and/or the medium to receive or selectively receive the vibrational energy generated in response to operation of the acoustic device (e.g., a speaker phone, a noisy device, etc.). As noted, the computing system 110 may allow for the frequency of the vibrational energy received by the energy receiving device 102 to be dynamically modified.

Then, at step 126, the energy receiving device 102 may route the received energy information to the energy transducing device 104. The energy information may be routed through, for example, the connection 106 and/or the communication module 116 or dataport 118 of the computing system 110. The computing system 110 may use the software 111 to process the routed energy information, as described above. Next, at step 128, the energy dispensing device 104 may transduce the received energy information. For example, the energy dispensing device 104 may amplify the acoustic vibrations (e.g., amplify the received acoustic energy signal by increasing the decibel level of the acoustic energy signal), cancel out the acoustic vibrations (e.g., superimpose an out-of-phase acoustic signal to quiet the sound, provide motion to counteract the acoustic vibrations, etc.), convert the acoustic vibrations to an electric signal for storage in a battery and/or for powering a device, convert the acoustic vibrations into a wireless signal (e.g., Bluetooth, Wi-F), et cetera. The energy dispensing device 104 may be configured to carry out predetermined parameters of operation. Alternately or additionally, the operation of the energy transducing device 104 may be configured to be modified by a user, for example, via a user interface of the computing system 110, an analog actuator (e.g., a toggle, a knob, a switch), et cetera. At step 128, the computing system 110 may dynamically modify the input range, e.g., in response to a change in the operation of the acoustic device. Such may allow the system 100 to hone in on frequencies of interest while disregarding other frequencies, which may reduce processing time and system costs. In some embodiments, the input range may also be user settable.

The artisan will understand the steps of the method 120 may be modified or omitted as desired, and additional steps not expressly discussed herein may be added. For example, the energy receiving device 102 may route the received acoustic energy information to the energy transducing device 104 via the network 20.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the disclosure. Not all steps listed in the various figures need be carried out in the specific order described.

1. An acoustic energy management system, comprising:
an energy receiving device configured to receive an acoustic signal within an input range;
an energy dispensing device configured to output a modified signal in response to the acoustic signal;
a computing device coupling the energy receiving device to the energy dispensing device, the computing device configured to dynamically adjust the input range; and
a portable housing for housing each of the energy receiving device and the energy dispensing device.

2. The acoustic energy management system of claim 1, wherein the energy receiving device comprises a tuned port.

3. The acoustic energy management system of claim 1, wherein the energy receiving device includes a contact for contacting a vibrating object.

4. The acoustic energy management system of claim 3, wherein the input range is a frequency range.

5. The acoustic energy management system of claim 1, wherein the energy dispensing device includes a microphone.

6. The acoustic energy management system of claim 1, further comprising a network storage remote from the portable housing.

7. The acoustic energy management system of claim 1 wherein a user interface is usable to adjust the modified signal.

8. The acoustic energy management system of claim 1, wherein the energy receiving device includes a bandpass filter.

9. A method of managing an acoustic signal, comprising:
using an energy receiving device to receive an acoustic signal within an input range;
processing the acoustic signal;
using an energy dispensing device to output the processed acoustic signal; and
configuring a computing device to dynamically adjust the input range.

10. The method of claim 9, further comprising processing the acoustic signal by amplifying at least a component thereof.

11. The method of claim 9, further comprising processing the acoustic signal by canceling at least a component thereof.

12. The method of claim 9, wherein the input range is within an audible frequency range.

13. The method of claim 9, further comprising arranging the energy receiving device and the energy dispensing device in a portable housing.

14. The method of claim 9, wherein the energy receiving device includes a tuned port.

15. The method of claim 14, wherein the energy dispensing device includes a speaker.

16. The method of claim 15, wherein the computing device is coupled to a network storage.

17. An acoustic energy management system, comprising:
an energy receiving device configured to receive an acoustic signal within an input range;
an energy dispensing device configured to output a modified signal in response to the acoustic signal;
a computing device coupling the energy receiving device to the energy dispensing device; and
a user interface comprising an analog actuator;
wherein, the input range is user selectable.

18. The acoustic energy management system of claim 17, further comprising a portable housing for housing the energy receiving device and the energy dispensing device.

19. The acoustic energy management system of claim 17, wherein the input range is a frequency range.

20. The acoustic energy management system of claim 19, wherein:
the energy receiving device comprises a tuned port; and
the energy receiving device includes a contact for contacting a vibrating object.
